(19) United States
(12) Patent Application Publication
(10) Pub. No.: US 2013/0151687 A1
(43) Pub. Date: Jun. 13, 2013

(54) Systems and Methods for Monitoring Content Consumption

(71) Applicant: Mark Randall Mooneyham, Folsom, CA (US)

(72) Inventor: Mark Randall Mooneyham, Folsom, CA (US)

(73) Assignee: Adobe Systems Incorporated, San Jose, CA (US)

(21) Appl. No.: 12/127,981

(22) Filed: May 28, 2008

(51) Int. Cl. G06F 15/173

(52) U.S. Cl. 709/224

(57) ABSTRACT

Embodiments provide methods and systems for monitoring consumption of pieces of content. One exemplary embodiment is a method that comprises providing an identification of a piece of content for incorporation into the piece of content. When the piece of content is consumed at a consumption environment (e.g., on a particular instance of a video content player), the identification of the piece of content is extracted and sent to a consumption monitor along with an identification of the consumption environment. This information is used to monitor consumption of the piece of content at the consumption monitor. For example, monitoring consumption may involve counting the number of unique consumption environments in which the piece of content was or is being consumed.

### FIELD

Embodiments of the disclosure relate generally to media, and more specifically to systems and methods of monitoring how content is used or otherwise consumed.

### BACKGROUND

Measuring how media content is consumed by an audience is often important. Such measurement may be particularly important when advertising is involved and payment for such advertising is based on consumption levels. There are often significant and costly efforts to measure official distribution channel consumption and discourage consumption through unofficial providers. For example, media distributed by a television network may be captured and uploaded to one, two, or hundreds of unofficial web providers or sent through e-mail chains. These scenarios are frustrating to content publishers who may have advertising arrangements that are based on consumption of advertisements inserted inside content, for example fees based on the number of times an advertisement inside a television news story is viewed. A publisher may have contracted to advertise and deliver a certain number of advertisements within a certain time period, and be unable to account for copied content (including the advertisement) made available by the other provider(s). Such content publishers do not get the credit they deserve because the true nature and size of the audience is not measured. Unable to get credit for the content consumption, the content publishers may try to prevent, discourage, or partner with third party providers. However, these techniques may require monitoring that may be cumbersome or impossible to administer given the number and distribution of other potential content providers and the speed with which media leaks.

### SUMMARY

Certain embodiments described herein provide methods and systems for monitoring consumption of a piece of content. One exemplary method comprises receiving an identification of a piece of content and an identification of a consumption environment in which the piece of content was or is being consumed. The identification of the consumption environment may distinguish the consumption environment from other consumption environments. For example, the consumption environment may be a particular instance of a video content playing software application, e.g., a particular instance of Adobe® Flash Player®. The method further comprises monitoring consumption of the piece of content, for example by counting the number of unique consumption environments in which the piece of content was or is being consumed. As a specific example, it may count that a particular piece of content was viewed on 2,222,222 different instances of the Adobe® Flash Player®, providing a useful estimate of the audience that consumed that piece of content. The consumption environment need not be an instance of software, however. In some embodiments, a consumption environment may relate to the IP address associated with a computer consuming the content and in others it may relate to a particular person. In still other embodiments, the environment may relate to one or more other attributes of a particular instance of a piece of content being consumed.

The method may also involve anonymizing the identification of the consumption environment. This makes the actual identity of the consuming environment unavailable while allowing the monitoring of consumption of the piece of content to recognize duplicate consumption environments. In other words, the particular user, computer, instance of software, IP address, and other attributes of the environment may be withheld or destroyed to protect the privacy of the consumer. For example, a hash algorithm may be used to convert the identification of the consumption environment to a cryptographically secure number that cannot be reversed and that is unique to the consumption environment. The secure number can be used, for example, to ensure that a given environment, e.g., that consumption on a particular instance of the Adobe® Flash Player® (and likely involving the same viewer) is not counted multiple times.

Certain embodiments provide a method of monitoring content consumption that comprise receiving a piece of content for consumption, extracting an identification of the piece of content from the piece of content, and sending to a consumption monitor the identification of the piece of content and an identification of a consumption environment in which the piece of content was or is being consumed.

Certain embodiments provide a method of monitoring content consumption that comprise receiving content for inclusion in a piece of content, receiving an identification for the piece of content, incorporating the identification in the piece of content, and publishing the piece of content. As examples, the identification in the piece of content may be incorporated or embedded as metadata or as a watermark.

In other embodiments, a computer-readable medium (such as, for example, random access memory or a computer disk) comprises code for carrying out these methods.

These embodiments are mentioned not to limit or define the disclosure, but to provide examples of embodiments to aid understanding thereof Embodiments are discussed in the Detailed Description, and further description is provided there. Advantages offered by the various embodiments may be further understood by examining this specification.

### BRIEF DESCRIPTION OF THE FIGURES

These and other features, aspects, and advantages of the present disclosure are better understood when the following Detailed Description is read with reference to the accompanying drawings, wherein:

FIG. 1 is a system diagram illustrating an illustrative network environment according to certain embodiments;

FIG. 2 illustrates an exemplary method of incorporating a content identifier in a piece of content according to certain embodiments;

FIG. 3 illustrates an exemplary method of notifying a monitoring engine upon consumption of a piece of content according to certain embodiments;

FIG. 4 illustrates an exemplary method of monitoring content consumption according to certain embodiments; and

FIG. 5 illustrates an exemplary method of monitoring consumption of a piece of content according to certain embodiments.

### DETAILED DESCRIPTION

Embodiments provide methods and systems for monitoring consumption of pieces of content. One exemplary embodiment is a method that comprises providing an identification of a piece of content for incorporation into the piece of content. When the piece of content is consumed at a consumption environment (e.g., on a particular instance of a video content player), the identification of the piece of content is extracted and sent to a consumption monitor along with an identification of the consumption environment. This information is used to monitor consumption of the piece of content at the consumption monitor, for example, to count the number of unique consumption environments in which the piece of content was or is being consumed.

### Illustrative Application of Monitoring Content Consumption

The following specific illustrative embodiment is provided to illustrate some of the applications, uses, and benefits of certain of the techniques for monitoring content consumption described herein.

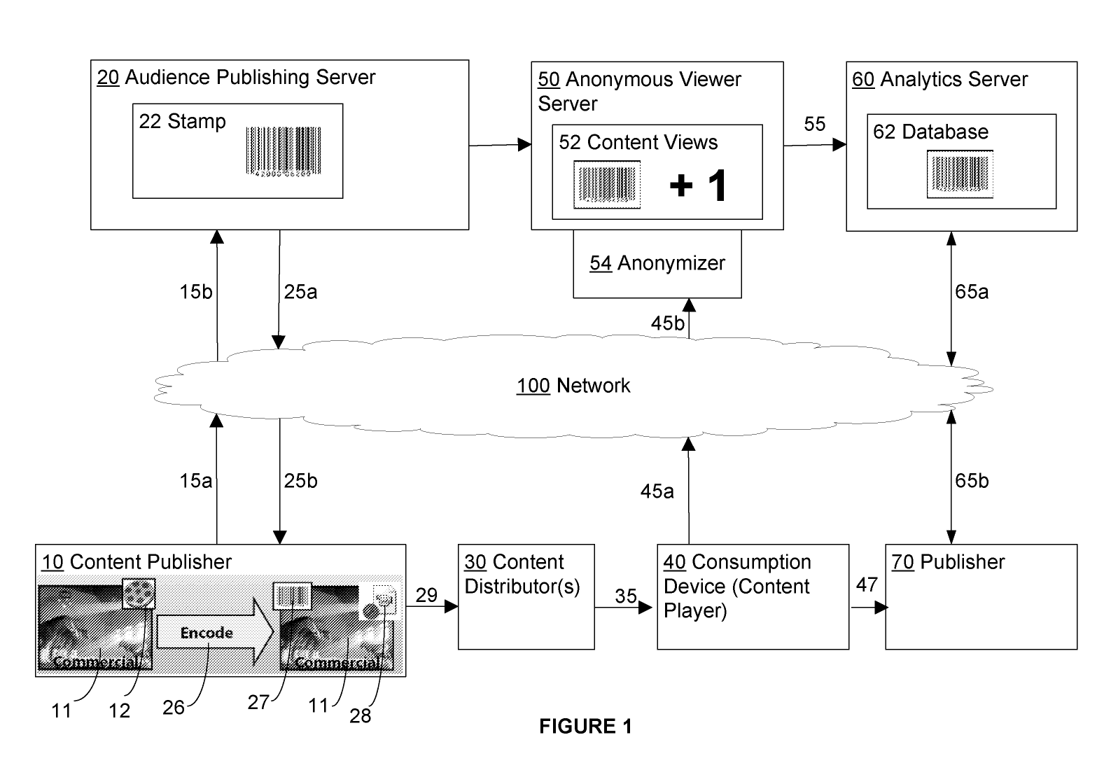

Referring now to the drawings in which like numerals indicate like elements throughout the several Figures, FIG. 1 is a system diagram illustrating an illustrative network environment according to certain embodiments. Other embodiments may be utilized. The environment 1 shown in FIG. 1 comprises a wired or wireless network 100 connecting various devices 10, 20, 30, 40, 50, 60, 70.

In this example, a commercial is to be published on television and on the television company's website as part of an evening news program. A content publisher 10 is used to encode 26 a piece of content 11, in this case the news program with the commercial which may have a video format 12, and include a content identifier 27. Here the content publisher 10 sends a request 15a, 15b to an audience publishing server 20 for a new content identifier 22, represented in FIG. 1 as a stamp and illustrated as a barcode. In practice, the identifier may be a number or have any other format.

The audience publishing server 20 may act as a source for content identifiers and provide a unique (at least unique for practical purposes) identifier for different pieces of content. In this case, the audience publishing server 20 responds to the request 15a, 15b by sending a message 25a, 25b comprising the new content identifier 22. The audience publishing server 20 may also send the identifier 22 and information about the piece of content to anonymous viewer server 50.

The new content identifier 22 sent to the content publisher 10 is encoded 26 into the commercial 11 as an encoded element 27. The process of including the content identifier may or may not give the content a new format 28. The encoding may, for example, involve including the new content identifier 27 as embedded metadata or as a watermark in the content 11.

The encoded content 29 is then published on the television show and on the television company's website. Other content distributors 30 copy the content and make it available for others to download or otherwise consume over the Internet 100. For example, as shown in FIG. 1, the encoded content 25 is sent to a particular user using a consumption device 40. The user uses an Internet browser (not shown) to download the content 35. Upon download, the browser initiates a content consuming application, for example, the Adobe® Flash Player® to play (i.e., consume) the content. Some identifying information about this consumption environment is recorded and sent to the anonymous viewer server 50. For example, the instance of the content consumption application may be used to uniquely identify the environment, e.g., the particular instance of the Adobe® Flash Player® used by the user.

The anonymizer 54 protects the user's privacy by removing any information that would identify the user's actual identity. For example, a hash algorithm may be used to convert the identification of the consumption environment to a cryptographically secure number that cannot be reversed and that is unique to the consumption environment. The content views counter 52 receives the anonymized identification that the content was consumed and increments its count for that piece of content by one. In this way, the anonymous viewer server 50 is able to keep track and otherwise monitor consumption of the piece of media, while protecting the privacy of the consumers. Note that in certain embodiments, the anonymizing function is performed elsewhere, for example, at the consumption device 40. Duplicates, e.g., when the user watches the news program again, are eliminated or otherwise not included in the count.

Information about the content being monitored 55 may be provided to an analytics server 60, that may comprise a database of information for many pieces of content published by multiple content publishers. The publisher of a piece of content 70 may correspond 65a, 65b with the analytic server to retrieve information about the consumption of a piece of content. In the present example, the television company providing the news program may query the analytic server to determine how many times the content containing the commercial 11 was consumed. Such information may provide the bases for the fee arrangement between the television company and the beneficiary of the commercial. For example, the commercial may be repeated in the nightly news until it has been consumed one million times. As another example, the price paid to the television company may depend upon the number of times the commercial was consumed.

This illustrative example is given to introduce the reader to the general subject matter discussed herein and is not intended to limit the scope of the disclosed concepts. The following sections describe various additional embodiments and examples of methods and systems for monitoring content consumption.

### Advantages of Monitoring Content

Certain embodiments of the present disclosure enhance content consumption software to recognize that it is playing a particular piece of content and report it to a monitoring engine. Such reporting may involve also providing an identification of the environment in which the content was consumed to ensure that duplicate (e.g., same location) consumption activity is not counted multiple times. This may further reduce fraud by preventing the simulation of content consumption.

Certain embodiments are further able to protect the privacy of the individual consumers by making the process anonymous and/or by using a trusted third party to monitor the consumption. For example, the identification of the consuming environment may include enough information to prevent duplication without revealing the identity of the user. However, information about a particular consumer or environment may be collected without identifying the consumer or environment, for example it may be recognized that a particular environment (e.g., a particular instance of a video content player) frequently watches a particular program, or that a particular product is consumed more commonly in the northeast United States than elsewhere in the United States. Thus, the environment identification information that is received may be examined for example, to use the IP address to get geographic code information, before it is discarded or altered. A variety of useful information may be harvested without compromising the individual consumer's privacy, including the geographic code, the time of use, and the web site the content was loaded from, among other things. It may be possible to develop behavioral profiles for viewers without actually knowing the viewers' identities.

Information may also be recorded about the providers of the content, e.g., the website from which the content was downloaded. This may facilitate the enforcement of copyrights and other intellectual property, among other things. This may also be useful in distinguishing between official and unofficial consumption. For example, in some cases official publication may have already been accounted for and it may be desirable to subtract out information in a monitored content count relating to the official consumption.

### Incorporating a Content Identifier

In certain embodiments, a unique identifier is encoded into a piece of content, for example, as metadata or included as a watermark (method of encoding information such that the modification is imperceptible to human senses). The encoding may also involve changing the format of the content to, for example, an MPEG file or other compressed file that streams over the web. The encoding may involve converting from whatever format the commercial originally is in (usually an uncompressed format) to one or more common computer network distribution content formats (e.g., Adobe® Flash® format) that may be compressed. At encode time, the encoder retrieves a unique content identifier from an audience publishing server and encodes it in the final output of the content. Incorporation of the identifier may be performed separately from the encoding or compressing of the content.

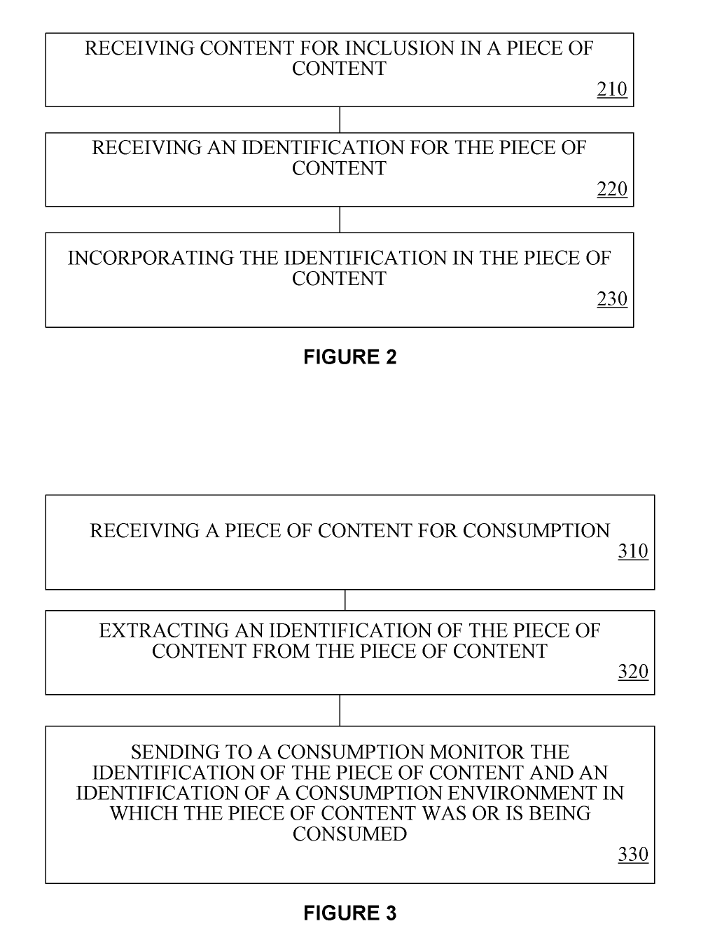

FIG. 2 illustrates an exemplary method of incorporating a content identifier in a piece of content according to certain embodiments. The method comprises receiving content for inclusion in a piece of content, as shown in block 210. For example, this may comprise retrieving a commercial and preparing to include it as part of a piece of news program content. The commercial itself may be the piece of content and thus this block may require nothing more than simply identifying and retrieving the commercial for use as a piece of content to be published.

The method further comprises receiving an identification for the piece of content, as shown in block 220. The identification will generally uniquely identify the piece of content and may be used to distinguish the piece of content from other pieces of content. The identification may be provided by a third party provider that provides identifiers for multiple pieces of content. An identification may, but need not, be a number or other character string. An identification may be generated locally, for example, from the content itself or by generating a very large random number.

The method may also comprise incorporating the identification in the piece of content, as shown in block 230. This may involve, for example, including a stamp or other attribute in a content file. For example, an identifier may be embedded metadata or included as a watermark. The incorporation of the identification of the piece of content may be part of an encrypting process. Once the identification has been incorporated, the piece of content is made available or otherwise published.

Water marking is a method of encoding information into a media file, into a video, audio, or other file such that the changes to the video and/or audio are imperceptible to a human but the computer can derive information back out of the files. Watermarking can provide certain advantages, including allowing incorporation of the content identifier in cases where the content format does not allow for a metadata field and also by making it hard to remove (intentionally or unintentionally) the content identifier. For example, unauthorized providers may re-encode a piece of content and strip away metadata in the process.

Additional information or metadata may also be incorporated in a piece of content, for example a few bits of information that represent a parental control rating may be included. Such information may be recognized by a media content player, and in accordance with user settings, facilitate a parent's wishes, e.g., preventing all viewing of anything with a rating stronger than PG 13.

### Sending Information From a Consuming Device

FIG. 3 illustrates an exemplary method of notifying a monitoring engine upon consumption of a piece of content according to certain embodiments. The method comprises receiving a piece of content for consumption, as shown in block 310. For example, a piece of content may be downloaded or streamed from a content provider on the Internet.

The method further comprises extracting an identification of the piece of content from the piece of content, as shown in block 320. This may involve extracting the identification from embedded metadata or from a watermark on the file.

The method may further comprise sending to a consumption monitor the identification of the piece of content and an identification of a consumption environment in which the piece of content was or is being consumed, as shown in block 330. The identification of the consumption environment distinguishes the consumption environment from other consumption environments. This allows duplicates (e.g., a user replaying the content on the same device) from counting as multiple consumptions. The consumption environment may be a particular IP address, a particular consumer identity, or a particular instance of consumption software used to consume the content, among other things. The identification of the consumption environment may be based upon but not identify an identifier unique to the consumption software used to consume the content and/or an IP address of the consumption environment.

The method may also comprise anonymizing the identification of the consumption environment. This makes the actual identity of consuming environment unavailable while still allowing monitoring of consumption of the piece of content to comprise recognizing duplicate consumption environments. Anonymizing the identification of the consumption environment may comprise using a hash algorithm to convert the identification of the consumption environment to a cryptographically secure number that cannot be reversed and that is unique to the consumption environment. It may make unavailable the IP address of the consumption environment and/or an identifier unique to the consumption software used to consume the content.

Certain embodiments involving media having a time component and address the scenario in which a consumer drops off in the midst of consuming a piece of content. These embodiments may involve sending multiple message during the course of consumption, e.g., every 10 or 15 seconds. This may provide information about how much of a piece of content is consumed, e.g., that 90% of consumers drop off within the first 5 minutes and before reaching the commercial portion of a piece of content.

### Using Consumption Information

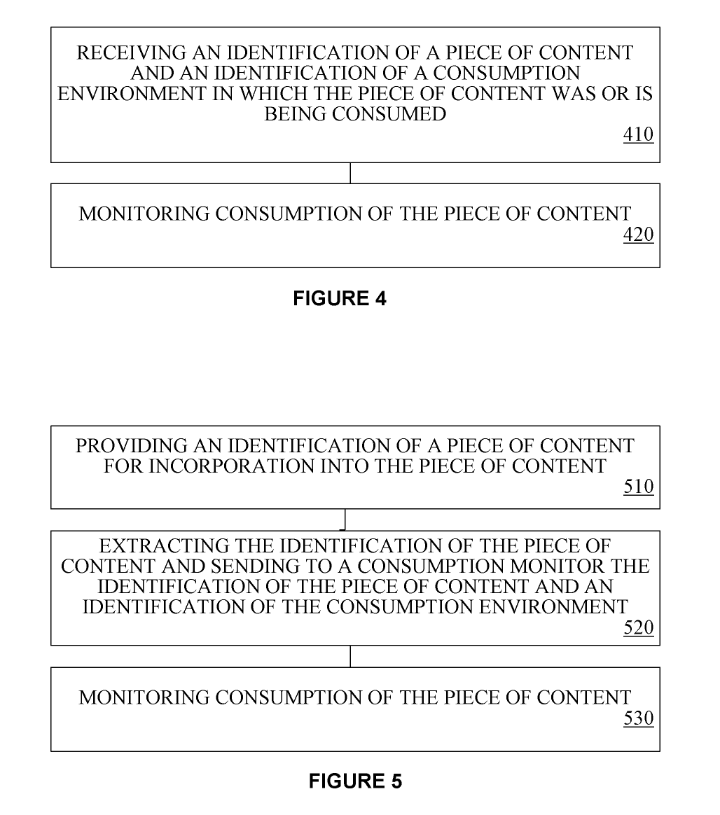

FIG. 4 illustrates an exemplary method of monitoring content consumption according to certain embodiments. The method comprises receiving an identification of a piece of content and an identification of a consumption environment in which the piece of content was or is being consumed, as shown in block 410. The identification of the consumption environment will generally distinguish the consumption environment from other consumption environments, but need not (and thus may or may not) actually identify the actual computing environment and/or consumer.

The method further comprises monitoring consumption of the piece of content, as shown in block 420. Monitoring consumption of the piece of content may comprise counting the number of unique consumption environments in which the piece of content was or is being consumed.

FIG. 5 illustrates an additional exemplary embodiment of monitoring consumption of a piece of content according to certain embodiments. The method comprises providing an identification of a piece of content for incorporation into the piece of content, as shown in block 510.

When the piece of content is consumed at a consumption environment, the method further comprises extracting the identification of the piece of content and sending to a consumption monitor the identification of the piece of content and an identification of the consumption environment, as shown in block 520. The identification of the consumption environment may distinguish the consumption environment from other consumption environments, but need not (and thus may or may not) actually identify the actual computing environment and/or consumer.

The method may further comprise monitoring consumption of the piece of content at the consumption monitor, as shown in block 530. This may comprise counting the number of unique consumption environments in which the piece of content was or is being consumed. It may involve determining a number of times the piece of content was consumed outside of official publishing channels by reducing the number of unique consumption environments by a number of times the content was viewed through official publishing channels.

Because advertisers usually want to audit the analytics information directly, a monitoring and/or analytics component may provide access to content consumption information to such advertisers directly. For example, if a content publisher has a primary account with multiple pieces of content being monitored, a particular advertiser may be given a sub-account allowing the advertiser to look at one specific piece of content with which the advertiser is associated.

Certain embodiments of the present disclosure provide methods of generating money based on the monitoring of content consumption. For example, a company monitoring the consumption of a piece of content could charge the content publisher a fee for information about the consumption. Different content publishers may of course be charged different fees. Similarly, fees may be based on consumption levels, so that low consumption levels generated by, for example amateur publishers, could involve minimal or no fees for associated content consumption information. Other business methods involve offering basic information for free and charging for more detailed information, e.g., offering a total consumption number for free but charging for details and/or analysis of the consumption.

### General

Certain embodiments relate to monitoring content consumption involving advertising and/or television commercials. These are merely illustrative. For example, certain embodiments will not involve advertising. In short, the techniques for monitoring content consumption and the other features described herein have uses in a variety of contexts, not to be limited by the specific illustrations provided herein. It should also be noted that embodiments may comprise systems having different architecture and information flows than those shown in the Figures. The systems shown are merely illustrative and are not intended to indicate that any system component, feature, or information flow is essential or necessary to any embodiment or limiting the scope of the present disclosure. The foregoing description of the embodiments has been presented only for the purpose of illustration and description and is not intended to be exhaustive or to limit the disclosure to the precise forms disclosed. Numerous modifications and adaptations are apparent to those skilled in the art without departing from the spirit and scope of the disclosure.

In addition, with respect to the computer implementations depicted in the Figures and described herein, certain details, known to those of skill in the art have been omitted. For example, applications that execute on each of the devices 10, 20, 30, 40, 50, 60, 70 and functions performed thereon are shown in FIG. 1 as functional or storage components on the respective devices. As is known to one of skill in the art, such applications may be resident in any suitable computer-readable medium and execute on any suitable processor. For example, the network devices 10, 20, 30, 40, 50, 60, 70 shown each may comprise a computer-readable medium such as a random access memory (RAM), coupled to a processor that executes computer-executable program instructions stored in memory. Such processors may comprise a microprocessor, an ASIC, a state machine, or other processor, and can be any of a number of computer processors. Such processors comprise, or may be in communication with a computer-readable medium which stores instructions that, when executed by the processor, cause the processor to perform the steps described herein.

A computer-readable medium may comprise, but is not limited to, an electronic, optical, magnetic, or other storage or transmission device capable of providing a processor with computer-readable instructions. Other examples comprise, but are not limited to, a floppy disk, CD-ROM, DVD, magnetic disk, memory chip, ROM, RAM, an ASIC, a configured processor, optical storage, magnetic tape or other magnetic storage, or any other medium from which a computer processor can read instructions. A computer-readable medium may transmit or carry instructions to a computer, including a router, private or public network, or other transmission device or channel, both wired and wireless. The instructions may comprise code from any suitable computer-programming language, including, for example, C, C++, C#, Visual Basic, Java, Python, Perl, and JavaScript.

While the network 100 shown in FIG. 1 may comprise the Internet, in other embodiments, other networks, such as an intranet, or no network may be used. Moreover, methods may operate within a single device. The devices 10, 20, 30, 40, 50, 60, 70 can be connected to a network 100 as shown. Alternative configurations are of course possible. The devices 10, 20, 30, 40, 50, 60, 70 may also comprise a number of external or internal devices such as a mouse, a CD-ROM, DVD, a keyboard, a display, or other input or output devices. Examples of devices are personal computers, digital assistants, personal digital assistants, cellular phones, mobile phones, smart phones, pagers, digital tablets, laptop computers, Internet appliances, set-top boxes, digital or analog video recorders, media players, processor-based devices, and television viewing devices. In general, a device may be any type of processor-based platform that operates on any operating system that may be capable of supporting one or more client applications or media content consuming programs. Similarly, the server devices depicted as single computer systems, may be implemented as a network of computers or processors. Examples of a server device are servers, mainframe computers, networked computers, a processor-based device, and similar types of systems and devices.

1. A method comprising:
receiving an identification of a piece of content and an identification of a consumption environment on a consumption device in which the piece of content was or is being consumed, wherein the consumption environment is a particular instance of consumption software used to consume the content on the consumption device, the identification of the consumption environment distinguishing the consumption environment from other consumption environments, wherein the other consumption environments are different instances of consumption software used to consume the content; and
monitoring consumption of the piece of content at more than one consumption environment, wherein monitoring consumption of the piece of content at more than one consumption environment comprises:
counting a number of unique consumption environments in which the piece of content was or is being consumed; and
making consumption environment identities unavailable while excluding duplicate consumption environments from the counting by anonymizing the identification of the consumption environment.

2. (canceled)

3. (canceled)

4. (canceled)

5. The method of claim 1, wherein anonymizing the identification of the consumption environment comprises using a hash algorithm to convert the identification of the consumption environment to a cryptographically secure number that cannot be reversed and that is unique to the consumption environment.

6. The method of claim 1, wherein anonymizing the identification of the consumption environment comprises making an IP address of the consumption environment unavailable.

7. The method of claim 1, wherein anonymizing the identification of the consumption environment comprises making unavailable an identifier unique to the consumption software used to consume the content.

8. The method of claim 1, wherein the identification of a consumption environment is based upon but does not identify the actual identity of the consumer consuming the content at the content environment.

9. The method of claim 1, wherein the identification of a consumption environment is based upon but does not identify an identifier unique to the consumption software used to consume the content.

10. The method of claim 1, wherein the identification of a consumption environment is based upon but does not identify an IP address of the consumption environment.

11. A method comprising;
receiving a piece of content for consumption;
extracting an identification of the piece of content from the piece of content;
sending to a consumption monitor the identification of the piece of content and an identification of a consumption environment in which the piece of content was or is being consumed, wherein the consumption environment is a particular instance of consumption software used to consume the content, the identification of the consumption environment distinguishing the consumption environment from other consumption environments, wherein the other consumption environments are different instances of consumption software used to consume the content,
wherein the consumption monitor monitors consumption of the piece of content at more than one consumption environment by counting a number of unique consumption environments in which the piece of content was or is being consumed and makes consumption environment identities unavailable while excluding duplicate consumption environments from the counting by anonymizing the identification of the consumption environment.

12. (canceled)

13. (canceled)

14. The method of claim 11, wherein anonymizing the identification of the consumption environment comprises using a hash algorithm to convert the identification of the consumption environment to a cryptographically secure number that cannot be reversed and that is unique to the consumption environment.

15. The method of claim 11, wherein anonymizing the identification of the consumption environment comprises making unavailable an IP address of the consumption environment or an identifier unique to the consumption software used to consume the content.

16. The method of claim 11, wherein the identification of a consumption environment is based upon but does not identify either an identifier unique to the consumption software used to consume the content or an IP address of the consumption environment.

17. A method comprising:
receiving content for inclusion in a piece of content;
receiving an identification for the piece of content;
incorporating the identification in the piece of content as embedded metadata or as a watermark; and
publishing the piece of content such that the piece of content is available for consumption by a particular consumption environment multiple times, wherein the particular consumption environment is a particular instance of consumption software used to consume the content,
wherein upon each consumption the identification is sent to a consumption monitor, wherein the consumption monitor monitors consumption of the piece of content at more than one consumption environment by counting a number of unique consumption environments in which the piece of content was or is being consumed and makes consumption environment identities unavailable while excluding duplicate consumption environments from the counting, wherein each of the unique consumption environments is a unique instance of consumption software used to consume the content.

18-20. (canceled)

21. A system comprising:
a content identifier provider for providing identifications that uniquely identify different pieces of content;
an encoding engine for receiving a content identifier from the content identifier provider and embedding the content identifier in a piece of content;
a content consumption device for (a) consuming a piece of content, (b) extracting the identifier of the piece of content from the piece of content, and (c) sending to a consumption monitor the identification of the piece of content and an identification of a consumption environment in which the piece of content was or is being consumed, wherein the consumption environment is a particular instance of consumption software used to consume the content, the identification of the consumption environment distinguishing the consumption environment from other consumption environments, wherein the other consumption environments are different instances of consumption software used to consume the content; and
a content consumption monitor for monitoring consumption of pieces of media, wherein the content consumption monitor monitors consumption of the piece of content at more than one consumption environment by counting a number of unique consumption environments in which the piece of content was or is being consumed and makes consumption environment identities unavailable while excluding duplicate consumption environments from the counting.

22. The system of claim 21, further comprising an analytic server for providing information about consumption of pieces of media.

23. A non-transitory computer-readable medium on which is encoded program code, the program code comprising:
program code for receiving an identification of a piece of content and an identification of a consumption environment in which the piece of content was or is being consumed, wherein the consumption environment is a particular instance of consumption software used to consume the content, the identification of the consumption environment distinguishing the consumption environment from other consumption environments, wherein the other consumption environments are different instances of consumption software used to consume the content; and
program code for monitoring consumption of the piece of content, wherein monitoring consumption of the piece of content comprises counting a number of unique consumption environments in which the piece of content was or is being consumed and making consumption environment identities unavailable while excluding duplicate consumption environments from the counting.

24. A non-transitory computer-readable medium on which is encoded program code, the program code comprising:
program code for receiving a piece of content for consumption;
program code for extracting an identification of the piece of content from the piece of content; and
program code for sending to a consumption monitor the identification of the piece of content and an identification of a consumption environment in which the piece of content was or is being consumed, wherein the consumption environment is a particular instance of consumption software used to consume the content, the identification of the consumption environment distinguishing the consumption environment from other consumption environments, wherein the other consumption environments are different instances of consumption software used to consume the content, wherein the consumption monitor monitors consumption of the piece of content at more than one consumption environment by counting a number of unique consumption environments in which the piece of content was or is being consumed and makes consumption environment identities unavailable while excluding duplicate consumption environments from the counting.

25. The method of claim 1 further comprising anonymizing the identification of the consumption environment, the anonymizing making the actual identity of the particular instance of consumption software unavailable while allowing the monitoring of consumption of the piece of content to comprise recognizing duplicate instances of the consumption software consuming the content.

26. A method comprising;
receiving a piece of content for consumption;
extracting an identification of the piece of content from the piece of content;
sending to a consumption monitor the identification of the piece of content and an identification of a consumption environment in which the piece of content was or is being consumed, wherein the consumption environment has a particular Internet Protocol (IP) address, the identification of the consumption environment distinguishing the consumption environment from other consumption environments, wherein the other consumption environments have other IP addresses,
wherein the consumption monitor monitors consumption of the piece of content at more than one consumption environment by counting a number of unique consumption environments in which the piece of content was or is being consumed and makes an identity of an IP address of the consumption environment unavailable while excluding duplicate consumption environments from the counting.

27. (canceled)
